(19) United States
(12) Patent Application Publication
(10) Pub. No.: US 2024/0165643 A1
(43) Pub. Date: May 23, 2024

(54) Device and Materials

(71) Applicant: QINETIQ LIMITED, Farnborough, Hampshire (GB)

(72) Inventor: Derek Michael Forrester, Farnborough, Hampshire (GB)

(21) Appl. No.: 18/550,867

(22) PCT Filed: Mar. 16, 2022
(86) PCT No.: PCT/GB2022/000027

§ 371 Date: Sep. 15, 2023

(30) Foreign Application Priority Data
Mar. 17, 2021 (GB) 2103938.3

(51) Int. Cl. B05B 7/14; B05B 7/16; B23K 26/362

(52) U.S. Cl. CPC B05B 7/1481; B05B 7/1666; B23K 26/362

(57) ABSTRACT

There is disclosed a spray gun for spray deposition of 2D material onto substrate surfaces so as to allow for subsequent laser patterning or etching of said material into a metamaterial. The gun comprises: a housing 1 capable of accepting a propulsion device for propulsion of the material, wherein said housing 1 accommodates a reservoir for loading material to be deposited by spraying: and a nozzle 4 for directing the material to be sprayed by the gun. The nozzle 4 includes converging and diverging inner bore sections so as to enable propulsion of material at a supersonic speed.

### FIELD

The present invention relates to an apparatus and methods for rapid manufacture of materials and products made therefrom.

### BACKGROUND

A global technology drive for 2D layered material device manufacture was spurred into action from 2004 when Geim and Novoselov et al published a seminal paper on electric field effects in atomically thin graphite films, known as graphene [1]. These atomically thin 2D materials, sometimes called single layer materials, have unique electrical, optical and thermal properties and offer potential building blocks for future electronic, and electromagnetic devices at the atomic level all the way up to the macro-scale.

Single layers i.e. 2D materials, can behave radically differently from their bulk counterparts. The properties are tunable as a function of the number of layers and whether there is an odd or even number of them. However, the majority of research on 2D materials has focused on results with only the purest forms and obtaining isolated small regions of single layers.

Previous methods of preparation have used chemical vapour deposition (CVD) [2], mechanical exfoliation/cleavage [3], and growth of epitaxial graphene for production of layered materials [4]. The best quality single layers have been produced by mechanical exfoliation [1] using the Scotch tape method that resulted in Nososelov and Geim receiving the Nobel Prize in 2010. However this requires a tedious continual thinning of small areas by sticky tape repeatedly being brought together and separated across the layered flakes until eventually the single or few layer flakes can be obtained. The obtained flakes are randomly distributed and require patient microscopy to be observed (typically on silicon wafers with 300 nm thick films of SiO2).

The CVD methods have been found to produce almost as high quality layered materials as mechanical exfoliation, but require high temperatures of greater than 1170 degrees K to do so. These temperatures severely limit the substrates that can be used, offer high operational costs, and limitations on the sample sizes that can be practically obtained. Furthermore, the deposited material is likely to be transferred to another substrate (one not usable in the CVD process) and hence has additional processing steps. It is also important to note that the thickness across CVD graphene multilayers (or other layered materials) is not uniform due to the difficulties in providing a homogeneous temperature inside the furnace. None of the existing methods are suitable for large scale manufacturing.

The present invention addresses the abovementioned problems with existing methods and offers further advantages.

### SUMMARY OF INVENTION

The present invention relates to new devices, methods and systems which enable the preparation of new materials, surfaces and articles. In embodiments good connectivity and self-assembly of layered materials can be achieved across almost any desired substrate. The substrates can be plastics, metals, rubbers, or glasses; with any flat or complex geometry.

The present invention is concerned with a kinetic spray deposition or kinetic deposition method (referred to herein as EkD) for preparing improved layered materials which can be combined with a laser patterning method for producing metasurface features into the layered materials. As defined herein, metasurfaces are patterned structures that can be subwavelength in planar geometries and/or thicknesses.

The present invention may have the advantage of producing CVD quality (or better) layers over large, not just small, areas, for example with quality as evidenced by Raman spectroscopy and SEM images. For example, embodiments of the present invention allows the creation of industrial scale metasurfaces that can coat vehicles, and other large structures, create smart buildings, and reach the full breadth of the potential of 2D material integration.

The present invention (EkD) may involve accelerating materials (e.g. as described herein) to high velocity (>250 m/s). Upon impact the flakes of material are pulled wrinkle free (plastically deformed) and form with smooth inter-connectivity. In one embodiment, lasing of a material with strong inplane covalent bonding and weak inter-layer van der Waals interactions changes the coupling strength of the inter-layers and this allows the indentation to propagate through the material leaving a permanent pattern.

The present invention provides processes and products as defined and claimed herein. In an aspect the present invention provides a spray gun for spray deposition of 2D material onto substrate surfaces so as to allow for subsequent laser patterning or etching of said material into a metamaterial. In further aspects the present invention provides a system comprising a spray gun and one or more lasers for preparing metamaterials, structured surfaces, topographic materials and topological materials, methods of using said system and products prepared therefrom. In further aspects the present invention provides methods of using said spray gun and system, and products prepared therefrom.

According to an aspect, there is provided a spray gun for spray deposition of 2D material onto substrate surfaces so as to allow for subsequent laser patterning or etching of said material into a metamaterial, wherein said gun comprises:
a housing capable of accepting a propulsion device for propulsion of the material, wherein said housing accommodates a reservoir for loading material to be deposited by spraying; and
a nozzle for directing the material to be sprayed by the gun;
wherein said nozzle includes converging and diverging inner bore sections so as to enable propulsion of material at a supersonic speed.

In an aspect the present invention provides a spray gun for spray deposition of 2D (single layer) material onto substrate surfaces so as to allow for subsequent laser patterning or etching of said material into a metamaterial,
wherein said gun comprises a housing capable of accepting a propulsion device for propulsion of the material and wherein said housing accommodates a reservoir for loading material to be deposited by spraying and a nozzle for directing the material to be sprayed by the gun,
wherein the material to be sprayed can be in a dispersion in a liquid, or in a liquid carrier or in solution or as a powder, and
wherein said nozzle barrel includes converging and diverging inner bore sections so as to enable propulsion of material at a supersonic speed,
wherein said housing is capable of delivering energy to the material equivalent to of at least 300 degrees centigrade,
wherein the gun is suitable for use at room temperature and pressure
and wherein deposition can be rapid, is capable of scaling to produce surfaces of sprayed material of at least 0.4 m in any one dimension, preferably greater than 1 m and more preferably greater than 10 m and more, and is suitable for surfaces with flat or complex topologies. By rapid is meant at least 1 m² in under a minute for <10 layers of 2D material.

+

In one embodiment the propulsion device is a compressor, preferably an air compressor or other device to force gas into the system (e.g. housing) at required (or predefined) pressures and velocities. In one embodiment the inner bore flow exit diameter (of the gun barrel) is approximately 1 cm, or 0.8-1.2. or 0.9-1.1 cm in diameter. In one embodiment a thermal jacket capable of adding heat of up to 500 degrees centigrade is provided for said housing to add extra energy to the system and provide a more uniform deposition of sprayed material. The gun may comprise a thermal jacket configured to heat said material up to 500 degrees centigrade.

In one embodiment the gun is capable of being hand held. In one embodiment solvents for said material are non-toxic for example selected from water, ethanol, iso-propanol and other polar solvents, or mixtures of solvents. In one embodiment the gun comprises the option of spraying under controlled gas environments for example spraying under argon or nitrogen gas other inert gas or providing a vacuum so as to control or alleviate oxidation and other changes in material functionality for example when thermal jackets and higher temperatures used.

In one embodiment the gun is adapted for use at room temperature and for scalability to production level by accelerating powders rather than liquids through the spray system and wherein layers of material are deposited without high thermal loads, producing coatings with low porosity and oxygen content. In one embodiment the materials to be sprayed are selected from metallic, semiconductor and insulator 2D materials, for example graphene, graphene oxide, molybdenum disulphide, and hexagonal boron nitride and wherein materials have different band gap properties.

One embodiment provides a laser for use with the gun wherein the laser is selected from a UV laser, 250-400 nm/visible light laser and low power 50-1000 mW laser.

In one embodiment high power lasers of differing wavelength are used so as to increase the deposition speed or different or lower power lasers used providing higher resolution/higher less resolution on patterned structures.

According to an aspect, there is provided a system comprising a gun according to any preceding statement and a laser for laser patterning or etching said material into a metamaterial. The laser may be a UV laser, 250-400 nm/visible light laser or a low power 50-1000 mW laser.

One aspect provides a method of using a gun or system as described above with respect to any preceding statement. Further aspects provide products produced from such methods, for example metasurfaces for electromagnetic control of elastomers, metals, plastics and glass surfaces.

According to an aspect, there is provided a method of using the gun as described above to deposit a 2D material onto a substrate surface.

The material may be: in a dispersion in a liquid; in a liquid carrier; in solution; or a powder.

The material may be provided as part of a solution which comprises non-toxic solvents.

The method may further comprise spraying the material onto the substrate surface under controlled gas environments so as to control or alleviate oxidation and other changes in material functionality.

The material may be a powder and the method may comprise spraying the powder through the spray gun to deposit layers of the material onto the substrate.

The material may be selected from metallic, semiconductor and insulator 2D materials.

According to another aspect, there is provided a method of using the system as described above to perform laser patterning or etching of said material. The laser patterning or etching may comprise: using high power lasers of differing wavelength; or using different or lower power lasers.

Methods of the present invention, including those which concern liquid or powder spray deposition, provide high quality uniform distributions of films whereas with conventional spraying methods the sprayed layers can be highly porous which are less suitable for some uses (embedded magnetic particles and dielectric particles). In some embodiments depositions of high quality large sheets of graphene multilayers, MoS2 and combinations of the two have been achieved, for example large sheets of graphene multi-layered material on flexible PVC substrate as well as a multilayer sheet of PVC/MoS2/Dye/Graphene. In some embodiments continuous surfaces have been achieved.

The method of (kinetic deposition of N-layered materials according to) the invention can also make use of flake like materials to deposit thin films. It is also possible to use spherical and elliptical particles for adhering to some surfaces. No toxic solvents were used in the making of the sprays or graphene powders.

### BRIEF DESCRIPTION OF THE DRAWINGS

The invention will be described solely by way of example and with reference to the accompanying drawings in which:

FIG. 1 shows a kinetic spray gun, designed for supersonic flow

FIG. 2 shows a front view of the gun

FIG. 3 shows a side view of the gun

FIG. 4 shows a side view of the separated gun

FIG. 5 shows the kinetic spray gun/laser modules coupled together

FIG. 6 as FIG. 5, showing inside the system

FIG. 7 shows the a rotatable sample holder

FIG. 8 shows a laser patterned 2D material

FIG. 9 shows a Raman spectroscopy image for defect free graphene multilayers

FIG. 10 shows the laser patterning of 2D material into a metasurface

FIG. 11 shows graphene on a glazed surface to provide a smart window

FIG. 12 shows a multilayer of 2D material on a flexible polymer

FIG. 13 shows hybrid structures of 2D materials

### DETAILED DESCRIPTION

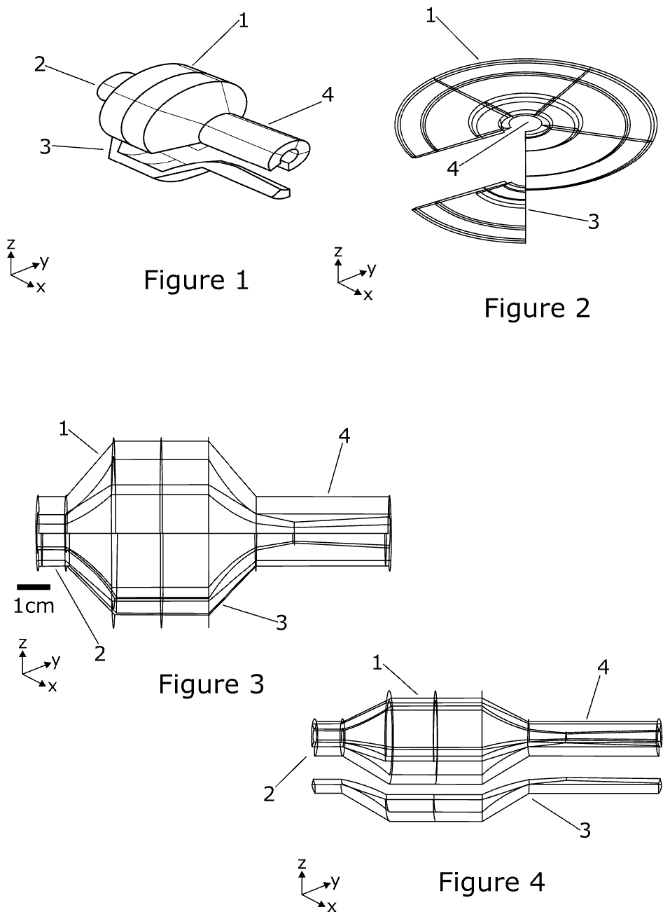

As is clearly shown in FIGS. 1-4, embodiments of the kinetic spray deposition gun includes a chamber 1 connected to a port 2 to connect to a propulsion device in the form of a compressor or portable compressed gas unit, directly or through piping. The port 2 comprises an inlet which is shaped to receive an outlet of the compressor.

A section 3 detaches from the gun to allow cleaning and direct loading of 2D material. That is, a section 3 of the gun which forms the chamber 1 (at least) is removable to allow access to the inside of the chamber 1 for cleaning purposes and for loading the chamber 1 with an amount of material to be used to form the 2D material. The section 3 may be removably attached to the remaining section of the gun using conventional attachment means.

The chamber 1 can hold an insert loaded with a measured amount of 2D material from which the material can be lifted into the air flow. The internal walls of the chamber 1 are shaped to define a reservoir or receptacle for holding the material.

At the front of the gun there is a converging diverging nozzle 4 to accelerate the flow of air and 2D material. That is, there is provided a nozzle 4 which is (e.g. connected) at an end of the chamber 1 opposite the inlet port 2. The nozzle 4 comprises an inner bore or channel having a (circular) cross-section of varying diameter or width. The nozzle is a converging-diverging nozzle having two sections: a first section adjacent the chamber 1 wherein the inner bore reduces in diameter in an airflow direction through the gun; and a second section (that which is longitudinally spaced from the chamber 1), wherein the inner bore increases in diameter in the airflow direction towards an outlet of the nozzle 4.

The internal walls of the port 2, chamber 1 and nozzle 4 define a flow path along which air is to flow through the gun in use. Specifically, air is introduced into the gun via the port 2 and exits the gun through the nozzle 4 via the chamber 1. The reservoir or receptacle of the chamber is in sufficient proximity to the airflow such that the material is drawn into the airflow as the air passes by. The airflow, which at this point includes the air and the material to be deposited, then flows through the nozzle 4 before exiting at an outlet of the nozzle 4 at the opposite end of the gun to the port 2.

By providing a converging-diverging nozzle, air introduced into the chamber 1 will flow from the chamber 1 through a converging channel before it then flows into a diverging channel before exiting the gun at the end of the nozzle 4 opposite the port 2. This nozzle structure enables propulsion of the material at a supersonic speed.

In one embodiment the kinetic spray gun is designed to attach to any suitable compressor system. The spraying transfers energy to the layered materials as they pass through the nozzle resulting in a very uniform deposition of well-connected 2D flakes without defects. The spray gun is designed to handle (material as) liquids or powders. A liquid phase quickly evaporates during flight. This provides an improvement in deposition quality over conventional spraying. It was found that a thermal jacket was advantageous in providing extra energy to the system (when using 2D materials in liquids) and provides a more uniform deposition. A chamber is added to the nozzle design that can be surrounded by a thermal jacket, giving temperatures up to 500° C. Higher temperatures can be used depending on the melting temperature of the material (aluminium, steel, others) used to make the spray gun. Powder form of 2D materials can be deposited at room temperature.

The kinetic spray gun is built in sections for ease of cleaning and manufacture. This also allows preloading of a powder. In one embodiment a small hole is bored into the chamber to inject the 2D material when in a liquid. The solutions of layered materials are in water, ethanol, iso-propanol or other solvents. Powder can also be injected and sweeps into the high velocity internal flow. This leads to the layers being deposited without high thermal loads, producing coatings with low porosity and oxygen content. Using either liquid or powder spray deposition can result in high quality uniform distributions of films.

With conventional spraying the layers can be highly porous, which may be what is required sometimes, but usually not. Thus, the kinetic spray methods are themselves adaptable to the requisite situation whilst being scalable to production level. The method is suitable for 2D metallic, semiconductor, or insulator materials and can be used to create combinations of 2D materials with different properties.

The kinetic spray system is contained in a unit with a laser. The two are separated by a device such as a rotating sample holder. The holder is secured by a lock either in the lasing or spraying position. Patterning multi-layered graphene materials using lasers propagates the patterns all the way through the bulk, changing the bond strength of the layers from weak van der Waal interaction to a stronger covalent bonding where the laser has passed [5].

In one embodiment this was shown to work broadly for all classes of 2D materials tested; transition metal dichalcogenides, graphenes, hexagonal boron nitride. This realisation allows the use of lower power lasers (200-500 mW) than have previously been used for patterning into 2D materials.

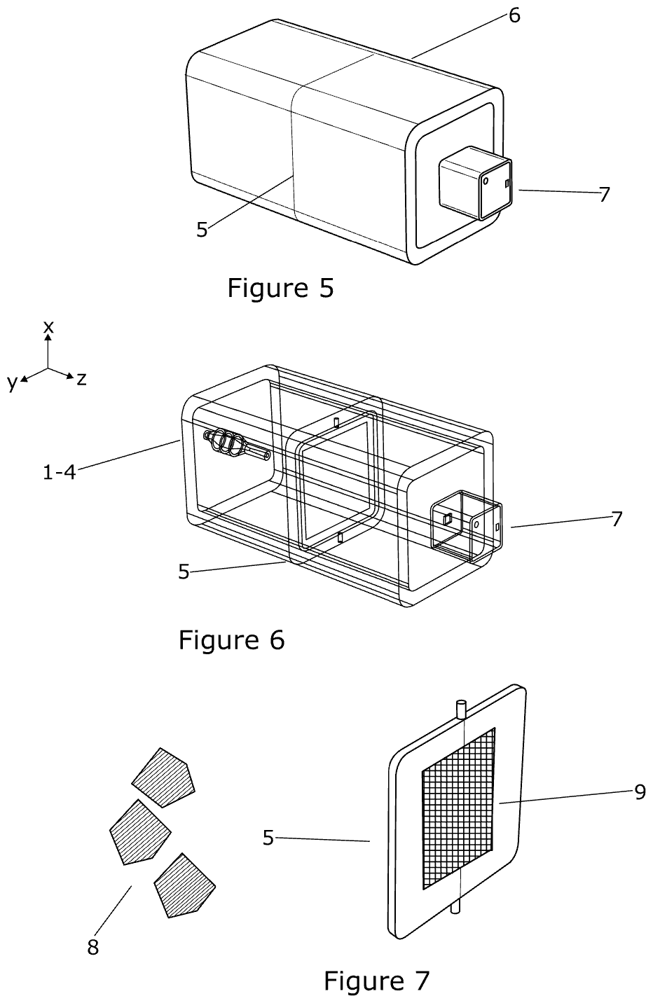

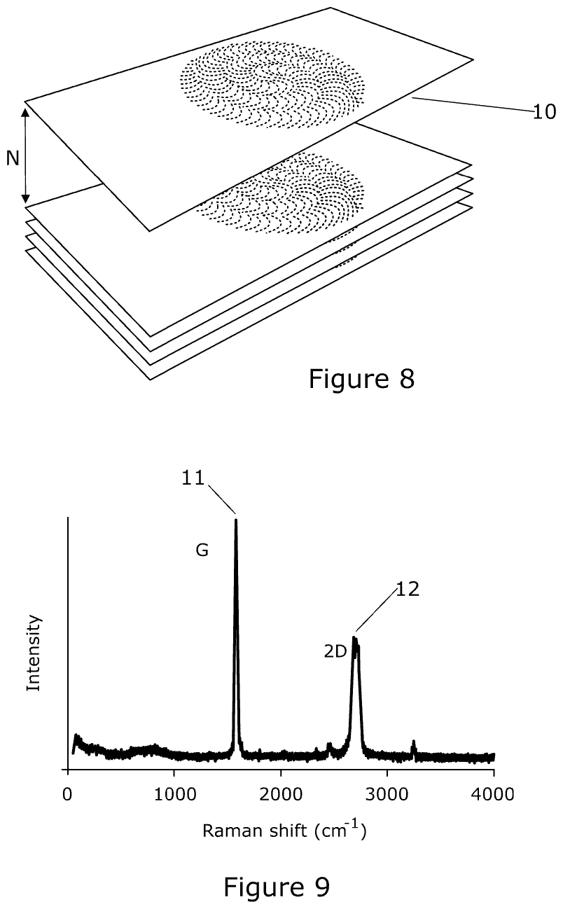

In the embodiment shown in FIG. 5-6, a laser 7 and kinetic spray gun 1-4 are housed in connecting modules 6 separated by a rotatable sample holder 5. The spray gun 1-4 is housed in one of the connecting modules such that the nozzle faces the sample holder and is suitable for directing the airflow and material towards the sample holder. The laser 7 is housed in the other of the two connecting modules such that the output of the laser is directed towards the sample holder 5. The sample faces either the laser or the spray gun. That is, the sample holder 5 is rotatable such that a substrate on which the material is to be deposited can be rotated between a first position, at which the substrate faces the spray gun nozzle, and a second position at which the substrate faces the laser. The sample holder 5 may be rotatable by a spindle mechanism, or any mechanism known in the art.

FIG. 7 shows 2D materials 8 are fired at and deposited onto the substrate 9 held in the holder, before rotating the holder such that the material deposited on the substrate 9 faces the laser for pattering. The laser and deposition system be embodied as a hand-held device, desktop unit, or roll-to-roll system. The laser need only mark the top-most layers of the 2D layered material for the image to become permanent down to the underlying substrate (e.g. glass, metal, and polymer). This effect was first described in [5] for graphene on glass. In the current embodiment it has been found that this low power lasing method is applicable to broad classes of 2D materials, which are also known as van der Waals materials [10 and 15].

In one embodiment a laser and deposition system (e.g. FIGS. 1-7) works to carry out this embedded patterning of N-layered materials, changing weak van der Waal coupling between layers to stronger covalent bonding where the laser passes. Once an image has been produced on the surface of the layered materials, it is not necessary to continue burning down to the substrate layer. If this were to be done it would be a long process with this power of laser (<800 mW) and would produce a negative image of the desired work.

In one embodiment the method used allows exact reproduction of the image as it is drawn (positive image). The exact pattern can be removed by an adhesive tape to peel the layers of the material from the surface. At this point a choice to exfoliate layers with the patterned image on the tape and transfer it to another substrate can be made. Alternatively continual removal of the layers can be performed layer by layer using a Scotch tape method until an image on the glass substrate is obtained with the optical properties required for a design, e.g. few layered 2D materials. This method can be used for many layers of 2D materials or few layers.

For graphene deposition, layer number distribution across the surface was investigated on 1 cm square silicon substrates by comparing the associated Raman spectral intensity of the G (11) and 2D (12) bands, respectively, at the frequencies ω_{G} and ω_{2D} (see, FIG. 9). The intensity ratio of the G and 2D bands (I_{G}/I_{2D}) identifies the local layer numbers. Conventionally, an I_{G}/I_{2D} ratio of <0.5 corresponds to single layer graphene (N=1), a ratio of 1.5 relates to four-layer graphene (N=4) and a ratio of 2 denotes five-layer graphene (N=5). [10]. For kinetic deposition films the distribution and layer thickness of the flakes is very homogeneous. For such thin films and small substrates, a pass of the spray system takes only a second and produces approximately 4-5 layers (with I_{G}/I_{2D} ratio between 1.4 and 2).

A typical distribution of Raman peaks is shown in FIG. 9, where the I_{G}/I_{2D} ratio is 1.98 (with the G peak at 1576 cm⁻¹ and the 2D peak at 2690 cm⁻¹). No D mode is detectable in this instance (usually found around 1350 cm⁻¹), indicating that there are very few defects and that the graphene multilayers are of high quality. The scanning electron microscope images show that the flake sizes are quite large and connect cleanly at their intersections, and hence explains an increase in conductivity compared to conventionally sprayed graphene. It is important to note that none of the present dispersions of graphene make use of toxic solvents such as N-Methyl-2-pyrrolidone or Dimethylformamide (NMP/DMF) as per more traditional routes.

Likewise, Raman peaks were investigated for hBN and MoS2. There are two types of vibrational modes: those inside the layer (intralayers) and those due to vibration/movement of the layers (interlayer). Intralayer modes are described as the “fingerprint” modes that give insight into the layers chemical composition. The interlayer modes are lower frequency than the fingerprint modes. Molybdenum disulphide is identified through two peaks found at around 383 and 408 cm⁻¹.

Molybdenum disulphide was identified without significant defects in the EkD tests: modes were identified at ˜382 and 407 cm⁻¹ for different thicknesses). The movement of the peaks is produced by elastic strain. It is, however, difficult to determine the minimum thickness of the layers in the MoS₂ materials using Raman spectroscopy. For >4 layers the frequencies of both peaks converge towards bulk values. However, transmission electron microscopy (TEM) allows us to see the quality of the powders used in the dispersions. TEM analysis shows that the flakes are 2-6 layers thick. Hexagonal boron nitride has different Raman characteristics again, with a single Raman peak occurring around 1366 cm⁻¹. The Raman peak intensity diminishes as the number of layers increases. The distribution of the “white graphene multilayers” [see reference 5]” is uniform using EKD with low levels of defects. These layered materials are very well bound to the surface and impart their unique properties to the system they are deposited upon and in combination provide the possibility to create new devices, not limited to but including smart windows, transistors and sensors.

This deposition and patterning system can be used to produce functional materials. Patterning the N-layered materials using lasers propagates the patterns all the way through the bulk, changing the bond strength of the layers from weak van der Waal interaction to a stronger covalent bonding where the laser has passed. This new and advantageous feature allows the use of lower power lasers than have previously been used for patterning into 2D materials.

It is important to note that this method is largely using laser indentation rather than vaporisation of the layered material. Even for relatively thick films where the laser has patterned, the material exfoliation can be performed all the way down to near the substrate to leave patterns composed of few layer graphene, hBN, MoS₂, WS₂ or other layered materials. Hence, first the laser/EkD module is used to produce films and then the metasurface patterns are created using lasing.

These metasurfaces can be produced over large areas (many metres) and are highly promising for constructing lightweight, compact electromagnetic devices. The lasing is used in complement to EkD to produce a methodology that is scalable so as to allow the manufacture of coatings for future generations of smart technologies. In some embodiments of the system two or more lasers sweep the beam in the programmed direction and power to produce the functionalised layered materials.

An embodiment of the laser patterner element uses a pair of scanners mounted orthogonally (at right angles to one another) to control X and Y axis deflection. Each laser can pattern an area, e.g. 10 cm by 10 cm, and can work alongside a bank of other lasers. The benefit of having the laser move the beam through internal mirroring is that it eliminates the need for a movable x-y stage. In other embodiments the laser can move or the stage can move in a programmed pattern. The programming to control the laser beam is written in G-code.

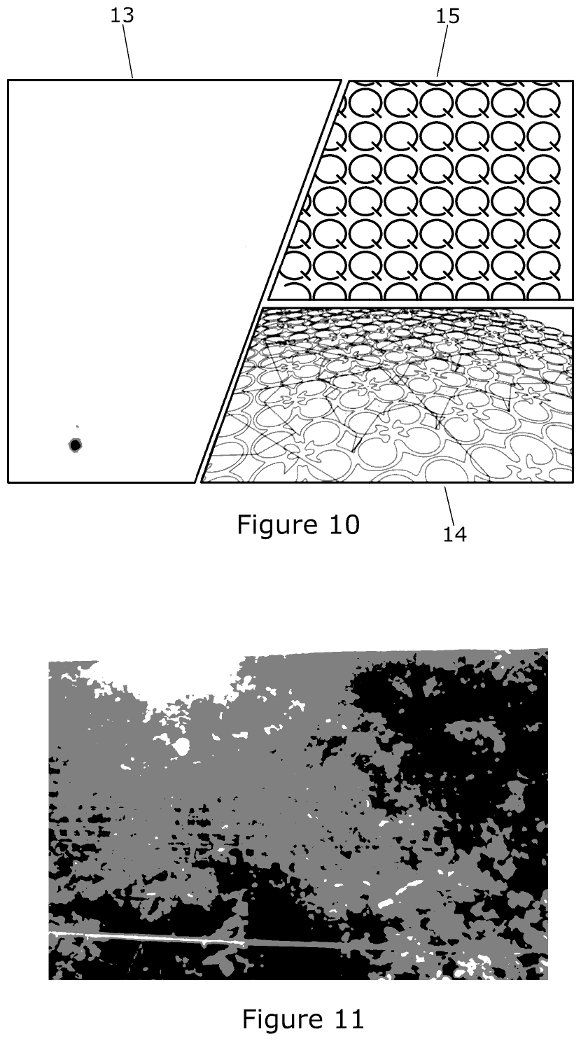

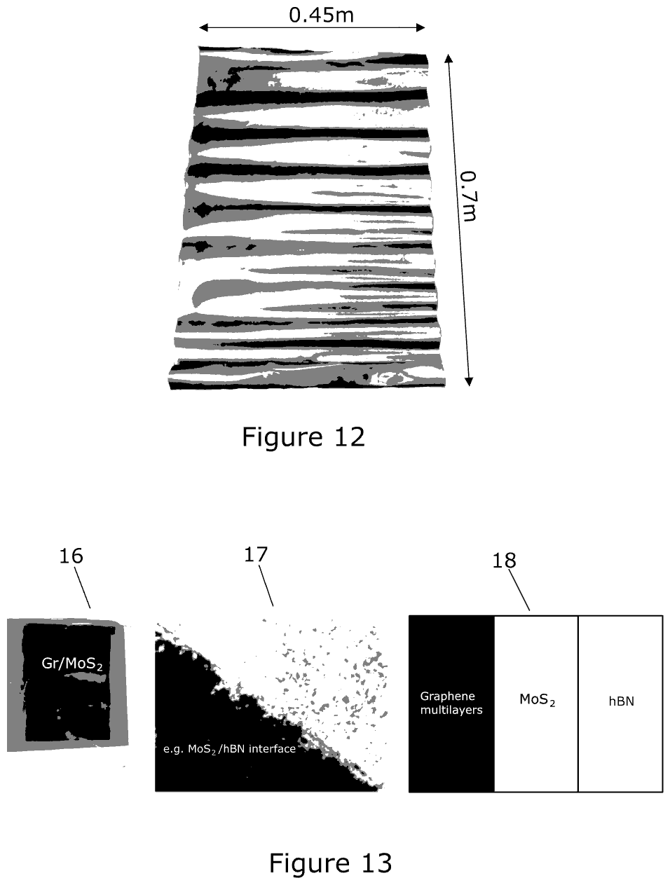

FIG. 10 demonstrates the lasing across a 2D material multilayer on a polymer film producing an array of split ring resonators 13 with the trajectories produced by the G-code or other programming language 14. A pattern 15 can be of any chosen image. These metasurfaces can be highly transparent or opaque. For example, graphene on glass double glazing produced using a laser/EkD module provides demonstration of the smart window concept of a functionalised window with metasurfaces for RF absorption (FIG. 11), enabling—for example—electromagnetic compatibility and shielding in buildings (e.g. blocking competing WiFi signals).

The size of the patterned structures can be made at the sizes smaller than the range of wavelengths of interest. Metasurfaces with periodic, or aperiodic, patterns of subwavelength-sized geometries enable a degree of engineering control over electromagnetic fields. The layered materials thickness is one control feature, but also the in-plane patterning allows subwavelength spacing. In one embodiment metasurfaces have been patterned using two lasers but there is no impediment to using more lasers and creating the rapid-prototyping of large scale devices. Graphene has been deposited onto and laser patterned on a glass window surface using a laser/EkD module. In one embodiment (FIG. 11) two arrays of graphene oxide squares are separated by 50 microns on PET and appears as optically transparent metasurfaces.

In one embodiment the patterning of few layer graphene on windows and large area glass is enabled, opening up the possibility to deposit functional layered materials on vehicle windscreens; windows in offices, factories, and homes; visors and optical equipment. Moreover, it was discovered that a laser/EkD module also allows the user to pattern onto plastics, elastomers, and metals as well as dielectrics. This is exceptionally powerful and potentially gives a broad capability to use multiple materials, over very large areas (many metres), facilitating embodiments as roll-to-roll or hand-held devices. Being able to cover large, complex shaped geometries, flexible or rigid substrates, with 2D materials is a desired capability in 2D materials engineering and science. An embodiment of the laser/EkD module is as a mobile technology—i.e. the deposition and lasing system can be used by an operator in the field in one embodiment or as part of a manufacturing process in another. Not only can the systems deposit on rigid materials but they can create well connected large areas on flexible materials.

In one embodiment a MoS₂/Dye/Graphene multilayer on flexible PVC is provided that can be used as a large area layered solar cell system. The dye layer is used to promote electron transport. As another example, graphene multilayers with 1 mm square grids separated by 0.25 mm on acrylic demonstrated a frequency selective surface (as per a microwave door) with 50% absorption at 40 GHz. The EkD/laser module produced materials can be designed for multiple uses, e.g. simultaneous electromagnetic control in different regimes of the spectrum.

Hybrid structures, where different layered materials are combined can be produced using the EkD/laser module. Rather than producing a multi-layered structure the films can also be deposited linearly through EkD and then laser patterned. In one embodiment (FIG. 13) graphene and MoS₂ multilayers are combined and wires connected to each end in series with an LED and switch to a battery.

A good conductivity to carry an electrical current to brightly light the LED is provided. Graphene multilayers with hBN and MoS₂ are combined in-plane over a flexible polyimide substrate (interface of MoS₂ and hBN in FIG. 13 part 16), and shown schematically in 17.—This combination of materials is important for incorporating the best properties of each 2D material, i.e. combinations of metals, semiconductors, insulators. The materials used are to be in flake form. The EkD/laser module system can be used for small sub-micron sized flakes (˜100 nm) to larger ˜100 micron sized flakes. The deposition of the 2D layered materials forms a homogeneous film over the desired substrate with good interconnectivity and a smooth surface finish.

Laser patterning is performed using ultraviolet wavelengths of light in these experiments but lower resolution can also be achieved in the patterning through use of longer wavelengths. Typically lasers of the UV-A class are used (315-400 nm) and visible violet light (up to 450 nm). Finer features are patterned using UV-B and C lasers (280-315 nm and 100-280 nm, respectively). It is desirable, to increase the quality of the flakes before deposition, though the deposition and lasing tool still works well with raw unprocessed flakes in powder form.

For example, high quality MoS₂ micron sized platelets of multi-layered MoS₂ were synthesised through a chelation-assisted sol gel method. To exfoliate the multi-layered structures a number of approaches were employed. (1) Chemical exfoliation where the resulting solution was then centrifuged and the supernatant removed before the MoS₂ was washed with water and further centrifuged in ethanol. (2)

Mechanical exfoliation with high shear mixing (for around one hour) of a dispersion in a solvent was also performed and followed by the same centrifugation steps as in the chemical exfoliation.

In each case the samples underwent drying in an oven after an ethanol clean and pouring off the supernatant from the compacted flakes at the bottom of the centrifuge tube. The chemical exfoliation resulted in more regular sized and higher percentage of single layers than the mechanical exfoliation, as might be expected. However, a mechanical exfoliation method is more straightforward, scalable, and still produces high quality MoS₂ layers. (3) Further exfoliation was carried out using bipolar electrochemistry. Small amounts of sodium chloride were added to water to intercalate the layers. MoS₂ solutions were prepared in pure water, ethanol and isopropanol for the purpose of deposition or used in powder form. It has been found that even lower quality MoS₂ flakes self-heal in deposition using the EkD/laser module and so this method is broadly applicable for use of even initially low N-layered quality flakes of 2D material. The high quality of the deposition makes possible a clean laser patterning on a well-connected, uniform film of N-layers.

According to one embodiment a modular device is provided that is capable of depositing high quality two-dimensional materials on any surface and patterns it into metasurfaces or other functional patterns. In one embodiment the system comprises a universal kinetic spray system coupled to a low power laser device. In one embodiment the high quality of the deposited 2D materials such as molybdenum disulphide, hexagonal boron nitride, graphene, or any layered material, is sufficient to allow the formation of metasurfaces and/or layers that can be used in applications including, but not limited to, electronics, photonics, plasmonics, acoustics, RF absorption. This enables a broad class of layered materials to be used for creating metasurfaces, metamaterials and other 2D material devices.

The present work demonstrates a new kinetic spray deposition and lasing method that produces good connectivity and self-assembly of layered materials across almost any desired substrate. The present invention has the benefit of being capable of providing layered materials with a uniform distribution. The substrates can be plastics, metals, rubbers, or glasses; with any flat or complex geometry. Conventional air-spray methods can be used to produce thin films. Whilst producing better films than spin-coating it is still challenging to produce uniform films over larger areas than a few square centimetres. Typically the conventional air-spraying of solutions containing layered materials is carried out at relatively low gauge pressures of about 2-3 bar.

To improve on conventional spray methods, a new deposition system was developed and connected to a standard compressor system. In one embodiment the range of pressures is from 5 to 12 bar, preferably 8 or 9 bar.

Particular embodiments include EkD spraying of Graphene, MoS₂ and PVC/MoS₂/Dye/Graphene. EkD spraying embodiments also includes sprayed materials on any substrates including temperature sensitive or topographic substrates (eg pitted substrates, paper). Ekd methods include spraying and laser patterning where a material exfoliation option can be performed all the way down to near the substrate to leave patterns composed of a few layers of graphene, hBN, MoS₂ etc. In one embodiment the EkD method can be used to produce a variety of films. In further embodiments metasurface patterns are created using lasing. Unique features of embodiments of the invention include the ability to produce the pattern at any depth desired (e.g. producing a pattern focused in the middle of a thick layer, or multiple layers or 3 D patterns in the structure (holograms). In one embodiment the laser focal point can be adjusted and sample positioned to optimise the patterning. The pattern can be drawn through many layers of the materials. Also, laser interference lithography can be performed using coherent beams into the 2D materials. One such embodiment is a Lloyd mirror arrangement where the interference patterns into the 2D materials are produced in the fringes of the interference patterns.

Other benefits of the invention include the ability to tailor the conductivity with power-hence graded structures in all dimensions. Other embodiments include continuous (functional) surfaces offering unique properties by way of light weight, low cost aircraft, building design etc. Embodiments include manufacture of aircraft wings etc.

In one embodiment there is provided a hand held laser deposition system to laser pattern graphene electronics directly onto live trees. In one embodiment a nozzle was 3D printed in 405 nm photosensitive resin and attached to a DOT-3E 1800 Swagelok double cylinder. The opaque nozzle has the advantage of allowing the visualisation of flow through the testing procedure.

The deposited material thickness is a function of the spraying time with the nozzle being swept over the substrate vertically and horizontally to provide a uniform coating. The kinetic spray method transfers energy to the layered materials as they pass through the nozzle, allowing self-healing of defects and smoothing flakes during flight. This will quickly evaporate the liquid phase and reduce disparate agglomeration. Again this provides an improvement in deposition quality over conventional spraying. In a further improvement the addition of a thermal jacket adds extra energy to the system and provides a more uniform deposition. In a further embodiment and second iteration of the deposition system a chamber can be added to the nozzle design that replaced the original double cylinder and enabled addition of the thermal jacket.

The spray gun can be built out of any suitable material including aluminium, steel and polymers. Plastics can be used. Metals have the advantage of durability. In one embodiment aluminium is used. Aluminium is cost effective, easy to work with and light and capable of high temperature usage up to approx. 660 degrees centigrade. In one embodiment the kinetic spray gun was built in two halves for ease of cleaning and manufacture.

The solutions of layered materials had water, ethanol or iso-propanol solvents. Other solvents which will evaporate sufficiently quickly can be used. It was found that even a water solvent evaporated quickly enough before flakes impacted the substrate as long as the temperature of the nozzle was maintained at ˜573K. A range of materials were used in the solvents: graphene, graphene oxide, molybdenum disulphide, and hexagonal boron nitride, for example. N-layered hexagonal boron nitride (hBN) is an electrically insulating material (with a monolayer having a bandgap of 5.8 eV) with behaviour quite different from graphene multilayers, despite being named “white graphene” [5].

The fracture strength of graphene decreases by more than 30% above eight layers compared to a single layer, whereas hBN strength is insensitive to the number of layers. This is on account of the increased in-plane sliding of graphene layers compared to hBN. This makes hBN a more suitable candidate for reinforcing composite materials requiring high mechanical strength [6]. Therefore, hBN deposition is particularly suited to EkD to ensure a good surface connectivity because it does not have the same inter-layer reduced friction that graphene multilayers do. The elastic strain energy dominates the formation of the layered deposition and is sufficient with high velocity flow to cause irreversible plastic deformation of the material. This means that upon impact with the substrate, the flakes, which are then stretched, hold to the surface and do not revert to their previous form.

The transition metal dichalcogenide molybdenum disulphide is also amenable to high energy spraying and with similar deposition qualities to graphene layers has excellent adhesion. Molybdenum disulphide is a transition metal dichalcogenide (TMD) with a bulk indirect bandgap of ˜1.2 eV [7]. When a single layer of the material is produced a direct bandgap of ˜1.8 eV emerges [8]. This means that unlike the bulk MoS₂, monolayers emit light strongly. This makes it an appropriate material for use in a range of electronic and optical applications. The presence of the bandgap makes MoS₂ a strong alternative or complementary material to combine with graphene (which itself does not have a bandgap). With a high sensitivity to both electronic and optical effects, MoS₂ can be used to translate electronic signals into light, or vice versa [9]. Each layer of MoS₂ has a thickness of ˜0.65 nm. A monolayer consists of two hexagonal planes of sulphur atoms with a hexagonal plane of molybdenum atoms between them. These layered materials can be deposited, like hBN and graphene, on a broad range of substrates, whether flat, curved, flexible or rigid. Maximising the surface coverage to fully utilise the large surface to volume ratios of layered materials is facilitated by the EkD method.

The use of the thermal jacket and higher temperatures does, however, produce the possibility that some types of layered materials will undergo oxidation and therefore change functionality after deposition. The present invention alleviates this through spraying in a controlled environment, e.g. containing nitrogen or argon gas.

An alternative solution is to design the system so that it operates equally well at room temperature. This was done by accelerating powders rather than liquids through the spray system. This led to the layers being deposited without high thermal loads, producing coatings with low porosity and oxygen content. Using either liquid or powder spray deposition can result in high quality uniform distributions of films. With conventional spraying the layers can be highly porous, which is usually not what is required. Thus, the kinetic spray methods are themselves adaptable to the requisite situation whilst being scalable to production level. For example, in some embodiments it has been possible to deposit high quality large sheets of graphene multilayers, MoS₂ and combinations of the two.

Patterning the N-layered materials using lasers propagates the patterns all the way through the bulk, changing the bond strength of the layers from weak van der Waal

interaction to a stronger covalent bonding where the laser has passed [15]. This realisation allows the use of lower power lasers than have previously been used for burning into graphene. It is important to note that this method is largely using laser indentation rather than vaporisation of the layered material. Even for relatively thick films where the laser has patterned, the material exfoliation can be performed all the way down to near the substrate to leave patterns composed of few layer graphene, hBN, MoS2 etc. Hence, first the EkD method was used to produce films and then the metasurface patterns were created using lasing.

These metasurfaces can be produced over large areas and are highly promising for constructing lightweight, compact devices, materials and structures, including electromagnetic ones. The lasing is used in complement to EkD to produce a methodology that is scalable and will allow the manufacture of coatings for next generation smart technologies. One embodiment provides an initial test setup for performing the laser patterning wherein two lasers sweep the beam in the programmed direction and power to produce the functionalised layered materials. During laser patterning the laser patterner uses a pair of scanners mounted orthogonally (at right angles to one another) to control X and Y axis deflection and a visible light laser of wavelength 450 nm. Lasing was also conducted at lower wavelengths from 380 nm upwards. Preferred wavelengths are between 380 nm to 450 nm with results as described herein. Wavelengths throughout the visible domain could also be used.

Very low powers can be used, typically up to 800 mW but can also work for powers as low as 50 mW. The maximum power output was 800 mW. Each laser is lightweight and portable. Banks of lasers can work together to pattern large surfaces. This was proven using two lasers working together. The working distance of the laser can be controlled with lensing. The weight of each laser module is <150 g and the operating temperature is from 5-40° C. in humidity up to 80%. Each laser can pattern an area of 10 cm by 10 cm and can work alongside a bank of other lasers. The benefit of having the laser move the beam through internal mirroring is that it eliminates the need for a movable x-y stage. This allows the user to design a roll-to-roll system for expansion of the technology and handheld portable devices.

Lasing/patterning-material exfoliation can be performed all the way down to near the substrate to leave patterns composed of few layer graphene, hBN, MoS2 etc. Hence, first the EkD method was used to produce films and then the metasurface patterns were created using lasing. Changing the frequency of the laser allows use of materials that are transparent to different wavelengths, e.g. UV, IR laser beams. Using the depth lasing technique produces metamaterials (i.e. sub-wavelength structures that fill 3D space), i.e. the ability to tailor the conductivity with power-hence creating graded structures in all dimensions.

Surface lasing to make metasurfaces demonstrated the control of the conductivity. Laser patterning onto the surface of molybdenum disulphide, hexagonal boron nitride and graphene was shown to propagate all the way through the layers. Thus, where the laser has patterned the material, the weak van-der Waals interaction changes to a stronger covalent bonding. In addition, the focal depth can be controlled so that inside a thick film of the material a pattern may be produced.

Mechanical shearing through resonance was also found to produce a thinning of the edge states of the flakes. Graphite is composed of many sheets of graphene that have inter-plane separation distances of about 0.335 nm. It has a characteristic slipperiness that results from strong bonding within its layers and relatively weak inter layer van der Waal bonding. Thus, the layers can slide past one another quite easily. The graphene multilayers can be further exfoliated using mechanical, chemical or electrochemical techniques. For example, cymatic treatment of graphene multilayers as a precursor to fused deposition of films on the surface of liquids results in few layer edge states upon transferral to a substrate.

It was observed that graphene flakes are highly responsive to magnetic fields and can be manipulated to assemble in predetermined ways. Graphene multilayers are highly diamagnetic and because of this can self-assemble according to the magnetic field distribution. For example, mechanically exfoliated graphene in water is placed upon a silicon substrate that lies atop a grid of 2 mm square edged neodymium magnets. The graphene seems to have two phases, one that appears silver and aligns in the space directly above the intersections between squares and another appearing back that occupies the square geometries. It is speculated that the thinning of the edges of the graphene, as observed in the Raman mapping of some embodiments (not shown), leads to a higher magnetic susceptibility in the silver flakes causing them to seek out the field intersection areas (the nodes). This low magnetic field strength assembly is similar to that observed for iron fillings. However, the nano-thickness of graphene means that a higher resolution is potentially attainable.

The magnetic sensitivity of our graphene multilayers makes them amenable for use as magnetic sensors. Another application is in making graphene displays with high resolution. Magnetic metasurfaces can be made to self-assemble and disperse in combination with a set of programmable magnetic fields, much like a kaleidoscope.

Flexible barium strontium titanate (BST)/conductive polymer metasurfaces have been prepared. The BST was spin coated onto the polymer before laser patterning.

### REFERENCES

[1] K. S. Novoselov, A. K. Geim and et al, “Electric Field Effect in Atomically Thin Carbon Films,” Science, vol. 306, no. 5696, pp. 666-669, 2004.
[2] X. Duan and et al, “Chemical vapour deposition growth of large single crystals of monolayer and bilayer graphene,” Nature Communications, vol. 4, p. 2096, 2013.
[3] D.-M. Tang, D. G. Kvashnin, S. Najmaei and et al, “Nanomechanical cleavage of molybdenum disulphide atomic layers,” Nature Communications, vol. 5, p. 3631, 2014.
[4] A. Ben Gouider Trabelsi, F. V. Kusmartsev, D. M. Forrester and et al, “The emergence of quantum capacitance in epitaxial graphene,” J. Mater. Chem. C, vol. 4, pp. 5829-5838, 2016.
[5] G. Cassabois, P. Valvin and B. Gil, “Hexagonal boron nitride is an indirect bandgap semiconductor,” Nature Photonics, vol. 10, pp. 262-267, 2016.
[6] A. Falin, Q. Cai, J. G. Santos and et al, “Mechanical properties of atomically thin boron nitride and the role of interlayer interactions,” Nature Communication, vol. 8, p. 15815, 2017.
[7] J. N. Coleman, M. Lotya, A. O'Neill and et al, “Two dimensional nanosheets produced by liquid exfoliation of layered materials,” Science, vol. 331, pp. 568-571, 2011.
[8] Jiaying Jian, Honglong Chang and Tao Xu, “Structure and Properties of Single-Layer MoS2 for Nano-Photoelectric Devices,” Materials, vol. 12, p. 198, 2019.
[9] Xiao Li and Hongwei Zhu, “Two-dimensional MoS2: Properties, preparation, and applications,” Journal of Materiomics, vol. 1, no. 1, pp. 33-44, 2015.
[10] A. Ben Gouider Trabelsi, F. Kusmartsev, M. B. Gaifullin, D. M. Forrester and et al, “Morphological imperfections of epitaxial graphene: from a hindrance to the generation of new photo-responses in the visible domain,” Nanoscale, vol. 9, pp. 11463-11474, 2017.
[11] Nanfei He, Q. Pan and W. Gao, “Graphene-Fiber-Based Supercapacitors Favor N-Methyl-2-pyrrolidone/Ethyl Acetate as the Spinning Solvent/Coagulant Combination,” ACS Appl. Mater. Interfaces, vol. 9, no. 29, pp. 24568-24576, 2017.
[12] Hong Li, Alex W. Contryman, Xiaofeng Qian and et al, “Optoelectronic crystal of artificial atoms in strain-textured molybdenum disulphide,” Nature Communications, vol. 6, p. 7381, 2015.
[13] R. V. Gorbachev, I. Riaz, P. N. Blake and et al, “hunting for monolayer boron nitride: optical and Raman signatures,” Small, vol. 7, no. 4, pp. 465-468, 2011.
[14] M. Pumera and et al, “Nonconductive layered hexagonal boron nitride exfoliation by bipolar electrochemistry,” Nanoscale, vol. 10, p. 7298, 2018.
[15] D. M. Forrester and H.-H. Forrester, “Rapid reproduction of complex images in graphite by laser etching and exfoliation,” AIMS Materials, vol. 4, no. 2, pp. 413-420, 2017.

1. A spray gun for spray deposition of 2D material onto substrate surfaces so as to allow for subsequent laser patterning or etching of said material into a metamaterial; wherein said gun comprises: a housing capable of accepting a propulsion device for propulsion of the material, wherein said housing accommodates a reservoir for loading material to be deposited by spraying; and a nozzle for directing the material to be sprayed by the gun;
wherein said nozzle includes converging and diverging inner bore sections so as to enable propulsion of material at a supersonic speed.

2. A gun according to claim 1 wherein the propulsion device is a compressor, preferably an air compressor or other device to force gas into the housing at predefined pressures and velocities.

3. A gun according to claim 1, wherein the inner bore flow exit diameter is approximately 1 cm, or 0.8-1.2, or 0.9-1.1 cm.

4. A gun according to claim 1, further comprising a thermal jacket configured to heat said material up to 500 degrees centigrade.

5. A gun according to claim 1, wherein the gun is capable of being hand held.

6. A system comprising a gun according to claim 1 and a laser for laser patterning or etching said material into a metamaterial.

7. A system according to claim 6, wherein the laser is a UV laser, 250-400 nm/visible light laser or a low power 50-1000 mW laser.

8. A method of using the gun as claimed in claim 1 to deposit a 2D material onto a substrate surface.

9. A method according to claim 8, wherein the material is: in a dispersion in a liquid; in a liquid carrier; in solution; or a powder.

10. A method according to claim 9, wherein the material is provided as part of a solution which comprises non-toxic solvents.

11. A method according to claim 8, further comprising spraying the material onto the substrate surface under controlled gas environments so as to control or alleviate oxidation and other changes in material functionality.

12. A method according to claim 9, wherein the material is a powder and the method comprises spraying the powder through the spray gun to deposit layers of the material onto the substrate.

13. A method according to claim 8, wherein the material is selected from metallic, semiconductor and insulator 2D materials.

14. A method of using the system as claimed in claim 6, to perform laser patterning or etching of said material.

15. A method according to claim 14, wherein the laser patterning or etching comprises: using high power lasers of differing wavelength; or using different or lower power lasers.

16. A gun according to claim 1, wherein the housing comprises a chamber which is connected to an inlet port for connecting to the propulsion device, wherein the nozzle is at an end of the chamber opposite the inlet port; said chamber having internal walls shaped to define the reservoir.

17. A gun according to claim 1, wherein the housing comprises a detachable section for accessing an inside of the housing.

18. A system according to claim 6, wherein the gun and the laser are housed in a unit and are separated by a rotatable sample holder, wherein the rotatable sample holder is securable in a lasing position and a spraying position.
